(19) United States
(12) Patent Application Publication
(10) Pub. No.: US 2010/0169565 A1
(43) Pub. Date: Jul. 1, 2010

(54) STORAGE DEVICE, ACCESS CONTROL DEVICE AND ELECTRONIC APPARATUS

(75) Inventor: Toshiaki KANEKO, Kawasaki (JP)

Correspondence Address: Fujitsu Management Services of America, Inc., 2318 Mill Road, Suite 1010, Alexandria, VA, 22314, US

(73) Assignee: FUJITSU LIMITED, Kawasaki (JP)

(21) Appl. No.: 12/582,411

(22) Filed: Oct. 20, 2009

(30) Foreign Application Priority Data
Dec. 26, 2008 (JP) 2008-332259

(51) Int. Cl. G06F 12/00

(52) U.S. Cl. 711/112; 711/154; 711/E12.001

(57) ABSTRACT

A storage device includes: an access section accessing data in a storage area; a command receiving section receiving a command designating an access-point and data access thereto within the storage area; a command distinguishing section distinguishing whether the command is a within-protection command designating an access-point within a protected area or an off-protection command designating an access-point outside the protected area; an off-protection-command control section causing the access section to access data at the access-point designated by the off-protection command; a within-protection-writing control section causing, when the within-protection command designates data-writing, the access section to write data at an alternative-point in an invisible-area, and records a correspondence between the access-point and the alternative-point; and a within-protection-reading control section finding, when the within-protection command designates data-reading, the alternative-point corresponding to the access-point based on the recorded correspondence, and causing the access section to read data from the found alternative-point.

### CROSS-REFERENCE TO RELATED APPLICATION

This application is based upon and claims the benefit of priority of the prior Japanese Patent Application No. 2008-332259, filed on Dec. 26, 2008, the entire contents of which are incorporated herein by reference.

### FIELD

The embodiments discussed herein are related to a storage device, an access control device and an electronic apparatus.

### BACKGROUND

Conventionally, hard disk drive (HDD), semiconductor memory, optical disk drive and the like are known as a storage device that stores data. Also, there is known an electronic apparatus that incorporates such a storage device and operates according to program data stored in the storage device. Information processing apparatus typified by personal computer is known as such an electronic apparatus. In addition, there is known a so-called built-in type of apparatus represented by, for example, a surveillance camera.

Program data stored in the electronic apparatuses and storage devices is often updated as required. However, operation in accordance with the program data often becomes improper due to failure of update or corruption of data. It is desirable that the program data causing such an inappropriate operation be further updated so that the program data is improved to operate properly, or be returned to the point in time in the past when the operation of the program data was proper by canceling the update. To return the program data to the point in time in the past in this way is generally called “recovery.”

As one of conventional techniques for performing recovery, there is known one in which program data for recovery is stored somewhere beforehand and the program data is copied to an electronic apparatus or storage device.

FIGS. 1A and 1B are diagrams that illustrate conventional recovery techniques.

FIGS. 1A and 1B respectively illustrate two types of conventional recovery technique. In each example illustrated here, the recovery of program data stored in a hard disk drive (HDD) is performed.

A recovery technique illustrated in FIG. 1A employs a recovery CD 2 that stores program data for recovery to recover the program data stored in an HDD 1. This program data for recovery is, for example, program data that is the same as that stored in the HDD 1 at the time of factory shipment. In recovery, the program data stored in the recovery CD 2 is read and copied to the HDD 1 thereby overwriting the program data in the HDD 1 so that the HDD 1 is returned to the factory-shipped state.

In a recovery technique illustrated in FIG. 1B, a hidden area 4 invisible to an OS or the like is provided in part of the storage area of an HDD 3. Program data for recovery is stored in this hidden area 4 (see, for example, Japanese Laid-open Patent Publications No. 2003-280914 and No. 2002-366359). In recovery, the program data stored in the hidden area 4 is read by a recovery OS or the like. The read program data is copied to the HDD 3 thereby overwriting the program data stored in a visible area in the HDD 3, so that the HDD 3 is returned to the factory-shipped state.

These types of recovery technique need the copying and overwriting of the program data, which requires time-consuming processing. Therefore, it is desired that the processing time be reduced.

Although the recovery of program data has been described so far by way of example here, the recovery of mere data, which is not a program, also suffers from similar circumstances.

### SUMMARY

A storage device, includes:

an access section that performs data access to a storage area where data is stored;

a command receiving section that receives a command including designation of an access point within the storage area and designation of data access to the access point, the command receiving section being capable of accepting designation of a point in a visible area defined within the storage area as the access point, while being incapable of accepting designation of a point in an invisible area except for the visible area as the access point;

a command distinguishing section that distinguishes whether the command received by the command receiving section is a within-protection command that designates an access point within a protected area defined in the visible area or an off-protection command that designates an access point outside the protected area in the visible area;

an off-protection command control section that causes the access section to perform data access to the access point designated by the off-protection command;

a within-protection writing control section that causes, when data writing is designated as the data access by the within-protection command, the access section to write data at an alternative point in the invisible area, and records a correspondence between the access point designated by the within-protection command and the alternative point; and

a within-protection reading control section that searches for and finds, when data reading is designated as the data access by the within-protection command, the alternative point corresponding to the access point designated by the within-protection command based on the recorded correspondence, and causes the access section to read data from the found alternative point.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are diagrams that illustrate conventional recovery techniques;

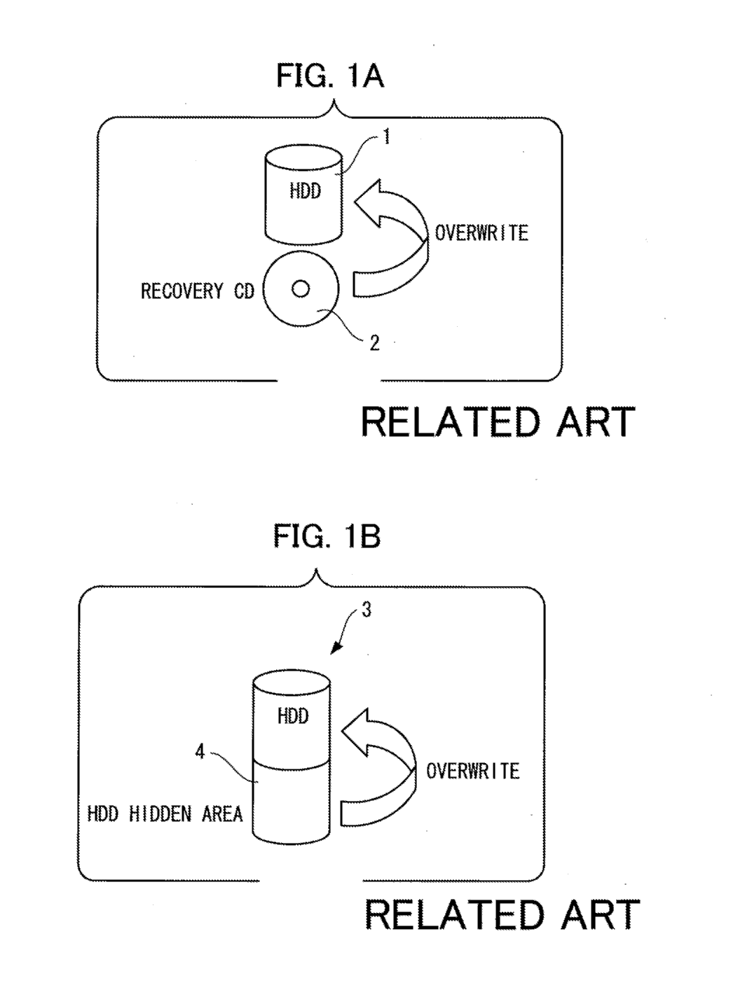

FIG. 2 is an external view of a personal computer according to a first embodiment;

FIG. 3 is a hardware block diagram of the personal computer;

FIG. 4 is a diagram that illustrates the structure of a HDD in detail;

FIG. 5 is a diagram that illustrates a control program stored in a storage circuit element;

FIG. 6 is a functional block diagram that illustrates the function implemented by the control circuit board when a processing circuit element executes the control program;

FIGS. 7A-7C are diagrams illustrating an outline of control at the time of data writing;

FIGS. 8A-8C are diagrams illustrating an outline of control at the time of data reading;

FIG. 9 is a flowchart illustrating the details of the contents of control at the time of data writing;

FIGS. 10A and 10B are diagrams that illustrate a storage state of data at the time of factory shipment;

FIGS. 11A and 11B are diagrams that illustrate writing of data under the control of an off-protection command control section;

FIGS. 12A and 12B are diagrams that illustrate a state in which data is written for the data state illustrated in FIGS. 11A and 11B by a within-protection writing control section;

FIG. 13 is a flowchart illustrating the details of the contents of the control at the time of data reading;

FIG. 14 is a diagram illustrating data reading under the control of the off-protection command control section;

FIGS. 15A and 15B are diagrams that illustrate a state in which the data in the state illustrated in FIGS. 10A and 10B is read under the control of a within-protection reading control section;

FIGS. 16A and 16B are diagrams that illustrate a state in which data in the state illustrated in FIGS. 12A and 12B is read under the control of the within-protection reading control section;

FIG. 17 is a diagram that illustrates a control program stored in a storage circuit element according to a second embodiment;

FIG. 18 is a functional block diagram that illustrates the function of a control circuit board in the second embodiment;

FIG. 19 is a diagram illustrating a table T′ used in the second embodiment;

FIG. 20 is a flowchart presenting data writing control by the control circuit board illustrated in FIG. 18;

FIG. 21 is a flowchart presenting data reading control by the control circuit board illustrated in FIG. 18;

FIGS. 22A and 22B are diagrams that illustrate a state in which data has been added for the first time after factory shipment;

FIGS. 23A and 23B are diagrams that illustrate a state in which data is further added after the state illustrated in FIGS. 22A and 22B;

FIGS. 24A and 24B are diagrams that illustrate a state in which reading of data in the state illustrated in FIGS. 23A and 23B is executed;

FIGS. 25A and 25B are diagrams that illustrate a state in which recovery of the data illustrated in FIGS. 24A and 24B is executed; and

FIGS. 26A and 26B are diagrams that illustrate a state in which reading of data in the state illustrated in FIGS. 25A and 25B is executed.

### DESCRIPTION OF EMBODIMENT

Embodiments of the storage device, access control device and electronic apparatus will be described with reference to the drawings.

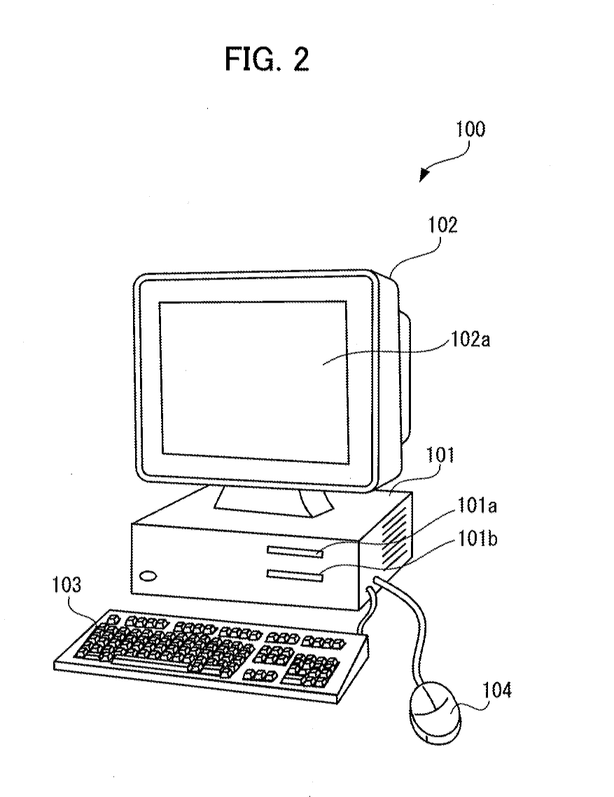

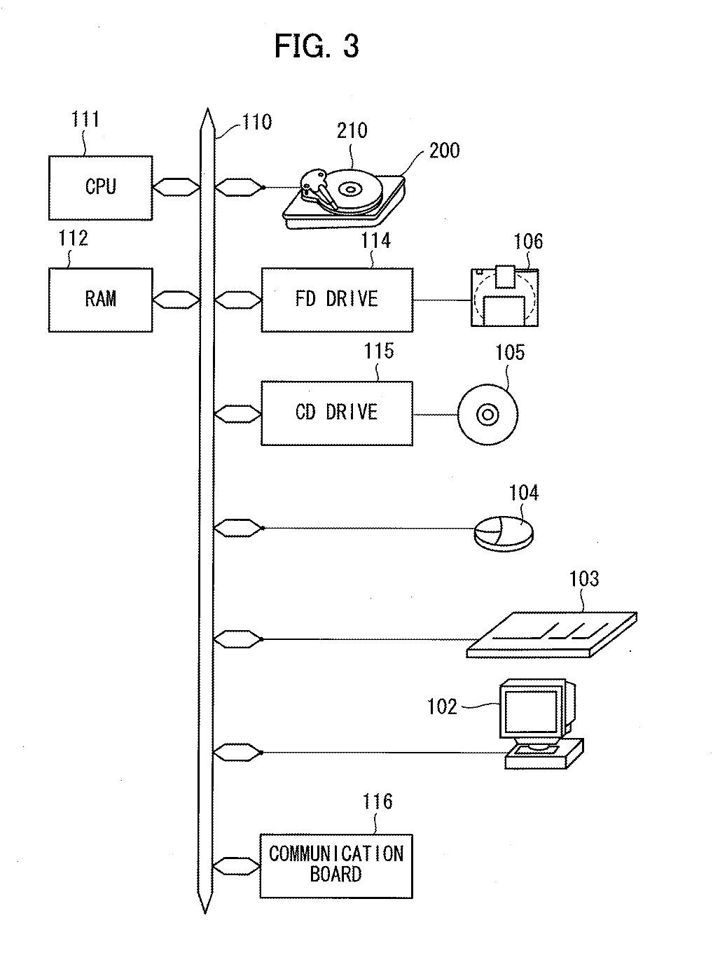

FIG. 2 is an external view of a personal computer 100 according to a first embodiment, and FIG. 3 is a hardware block diagram of the personal computer 100.

A personal computer 100 includes a main unit 101, a display unit 102, a keyboard 103 and a mouse 104. A CPU, a RAM, a hard disk and the like are built in the main unit 101. The display unit 102 displays a screen on a display surface 102a according to an instruction provided by the main unit 101. The keyboard 103 is used to input user instructions and character information into the personal computer 100. The mouse 104 is used to point an arbitrary location on the surface 102a to input an instruction corresponding to the location.

The main unit 101 further includes a flexible disc (FD) loading aperture 101a and a compact disc (CD) loading aperture 101b in its appearance. An FD 106 (not illustrated in FIG. 2, see FIG. 3) is loaded into the FD loading aperture 101a. Also, various types of CD medium such as a CD-ROM 105 (see FIG. 3), a CD-R, a CD-RW and the like may be loaded into the CD loading aperture 101b. Inside these FD loading aperture 101a and CD loading aperture 101b, an FD drive 114 for driving the loaded FD and a CD drive 115 for driving the loaded CD medium are provided (see FIG. 3).

As illustrated in FIG. 3, the personal computer 100 includes a central processing unit (CPU) 111, a RAM 112 and an HDD 200. Further, as described above, the FD drive 114, the CD drive 115, the display unit 102, the keyboard 103 and the mouse 104 are provided. Furthermore, a communicating board 116 is provided. These elements of the personal computer 100 are interconnected by a bus 110.

As described above, the FD drive 114 and the CD drive 115 access the FD 106 and the CD medium (CD-ROM 105 in this example), respectively.

The HDD 200 includes a magnetic disk 210 that stores an OS program and an application program. These OS program and application program are run by the CPU 111. When a program is actually run, the program stored in the magnetic disk 210 of the HDD 200 is read and loaded into the RAM 112, and then executed by the CPU 111.

The communicating board 116 is connected to and communicates through the Internet and the like. The OS program and application program stored in the magnetic disk 210 are updated as required through the communication via the communicating board 116. The updated OS program and application program are in a state in which a defect held before the update is resolved, or improved to deliver performance higher than before the update. However, the results of updating a program are not always excellent, often causing an inconvenience. For example, there is a case in which the updated program applies an excessively large load to the throughput of the personal computer 100. In this case, the operation of the personal computer 100 becomes unstable. Also, there is a case in which updating itself is a failure, corrupting a program. In this case, the personal computer 100 may operate improperly or become inoperable.

Besides the above-described inconveniences incident to the updating of a program, there is an inconvenience resulted from the continuation of operation of the personal computer 100. For example, there is a case in which when a large amount of data is input into the personal computer 100 and stored in the HDD 200 by a user, the amount of available space required for the operation of the personal computer 100 becomes short. In this case, the personal computer 100 becomes slow in operation or inoperable. The personal computer 100 may also become inoperable when infected with virus software through the Internet.

As an emergency measure to be taken when such an inconvenience occurs and cannot be readily resolved, there is the so-called “recovery.” The HDD 200 included in the personal computer 100 illustrated in FIG. 2 and FIG. 3 has the function of performing the recovery at a high speed. Now, the HDD 200 will be described in detail.

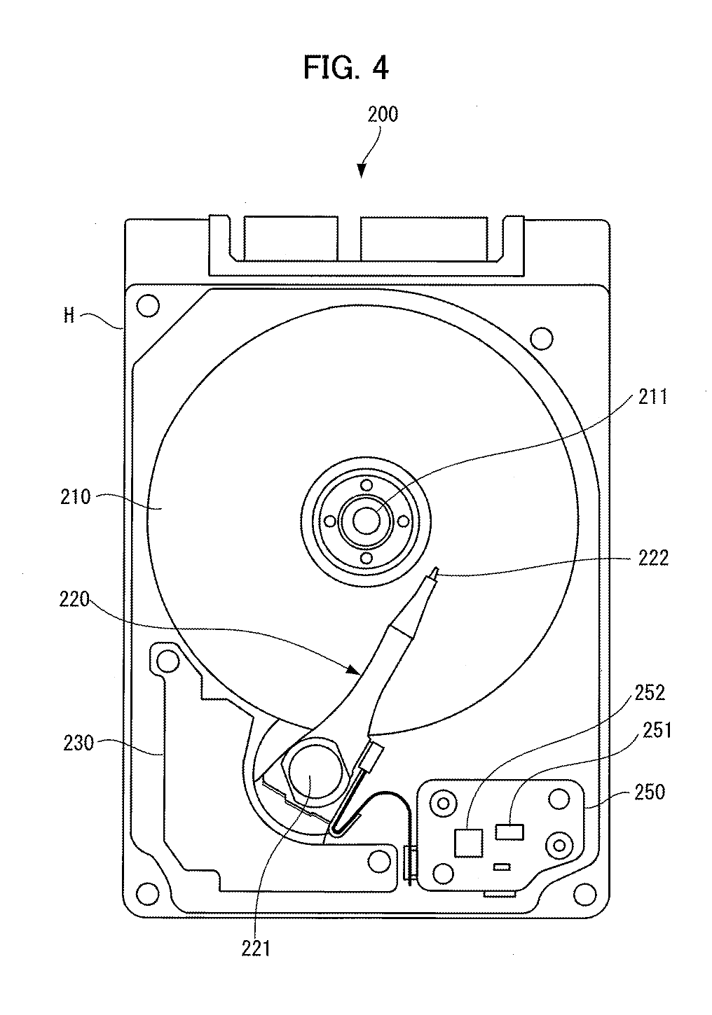

FIG. 4 is a diagram that illustrates the structure of the HDD 200 in detail.

The HDD 200 includes the magnetic disk 210 in the shape of a disc, a swing arm 220, an actuator 230 and a control circuit board 250, which are provided in a housing H.

Two or more magnetic disks 210 are stacked in the depth direction in the sheet of FIG. 4. The magnetic disks 210 are attached to a common disc shaft 211. The magnetic disks 210 rotate about the disc shaft 211 by receiving a driving force through the disc shaft 211. Data is magnetically stored on the surfaces of the magnetic disks 210.

The swing arm 220 is supported by an arm shaft 221. The swing arm 220 is capable of turning on the arm shaft 221 within a predetermined angle range. The actuator 230 is a so-called voice coil motor and produces a driving force to turn the swing arm 220. Also, a magnetic head 222 is provided at the tip of the swing arm 220. Therefore, the magnetic head 222 moves over the surface of the magnetic disk 210 when the swing arm 220 turns. The magnetic head 222 magnetically reads and writes data from and to a surface of the magnetic disk 210 (i.e. data access).

Reading and writing of data by the magnetic head 222 is executed under the control of the control circuit board 250. The control by the control circuit board 250 includes: control of reading and writing operation of the magnetic head 222; and control of the actuator 230 to determine the position of the magnetic head 222. The control circuit board 250 carries out the control according to a command from the CPU 111 illustrated in FIG. 3. The command from the CPU 111 is, specifically, a command from the OS. In the example illustrated here, the function of the control circuit board 250 is realized by running a program.

A storage circuit element 251 and a processing circuit element 252 are mounted on the control circuit board 250. These elements are both semiconductor integrated circuit elements. A control program is stored in the storage circuit element 251. Also, the processing circuit element 252 of the control circuit board 250 serves to execute the control program.

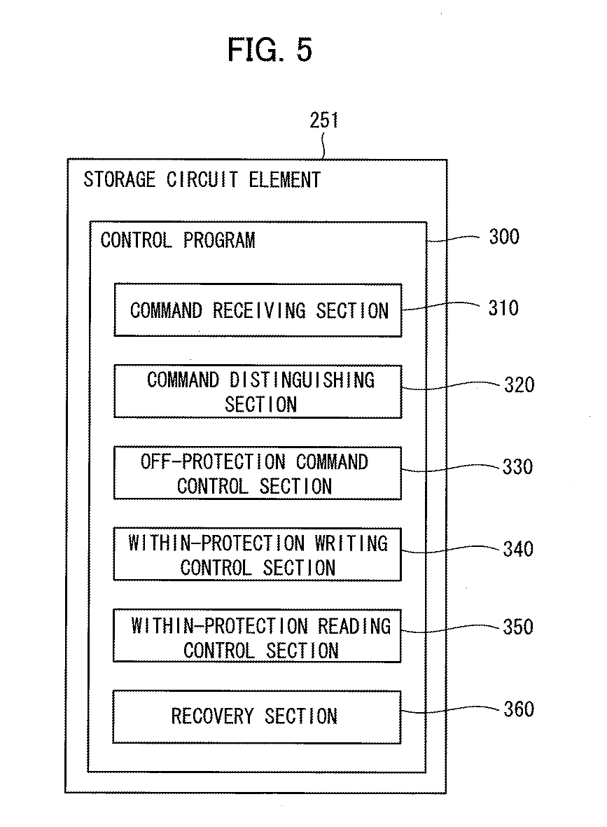

FIG. 5 is a diagram that illustrates the control program 300 stored in the storage circuit element 251.

As mentioned earlier, the control program 300 is stored in the storage circuit element 251. The control program 300 includes a command receiving section 310 and a command distinguishing section 320. The control program 300 further includes an off-protection command control section 330, a within-protection writing control section 340, a within-protection reading control section 350, and a recovery section 360.

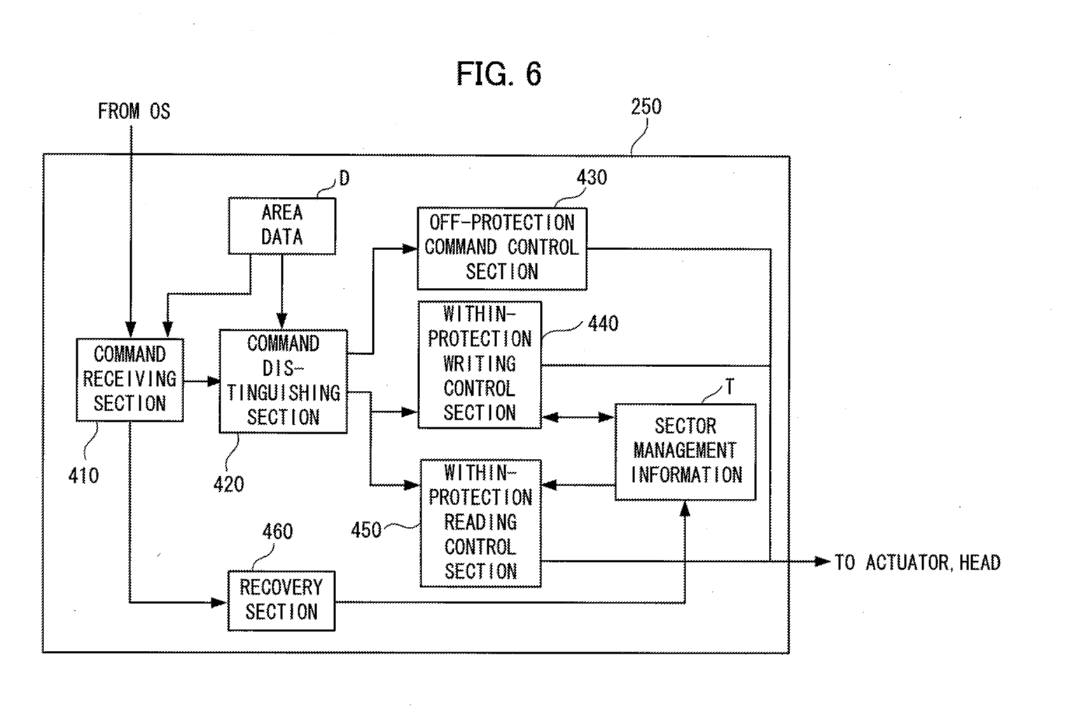

FIG. 6 is a functional block diagram that illustrates the function implemented by the control circuit board 250 when the processing circuit element 251 executes the control program 300.

When the control program 300 illustrated in FIG. 5 is executed, the control circuit board 250 serves as a command receiving section 410 and a command distinguishing section 420 indicated with the respective blocks in FIG. 6. The control circuit board 250 also serves as an off-protection command control section 430, a within-protection writing control section 440, a within-protection reading control section 450, and a recovery section 460. The command receiving section 410 of the control circuit board 250 illustrated in FIG. 6 is a function realized by the command receiving section 310 of the control program 300 illustrated in FIG. 5. Similarly, the command distinguishing section 420 through the recovery section 460 illustrated in FIG. 6 are functions realized by the command distinguishing section 320 through the recovery section 360 illustrated in FIG. 5, respectively.

The functions of the command receiving section 410, the command distinguishing section 420, the off-protection command control section 430, the within-protection writing control section 440, the within-protection reading control section 450 will be described later in detail.

As described earlier, the control circuit board 250 receives commands from the OS, and performs control operations. The command from the OS designates a point in the storage area of a magnetic disk and orders writing and reading of the data. In the example here, specifically, a sector is designated as a point in the storage area.

Now, a summary of the contents of the control carried out by the control circuit board 250 will be described first. Subsequently, its detail description including each function illustrated as the block in FIG. 6 will be provided.

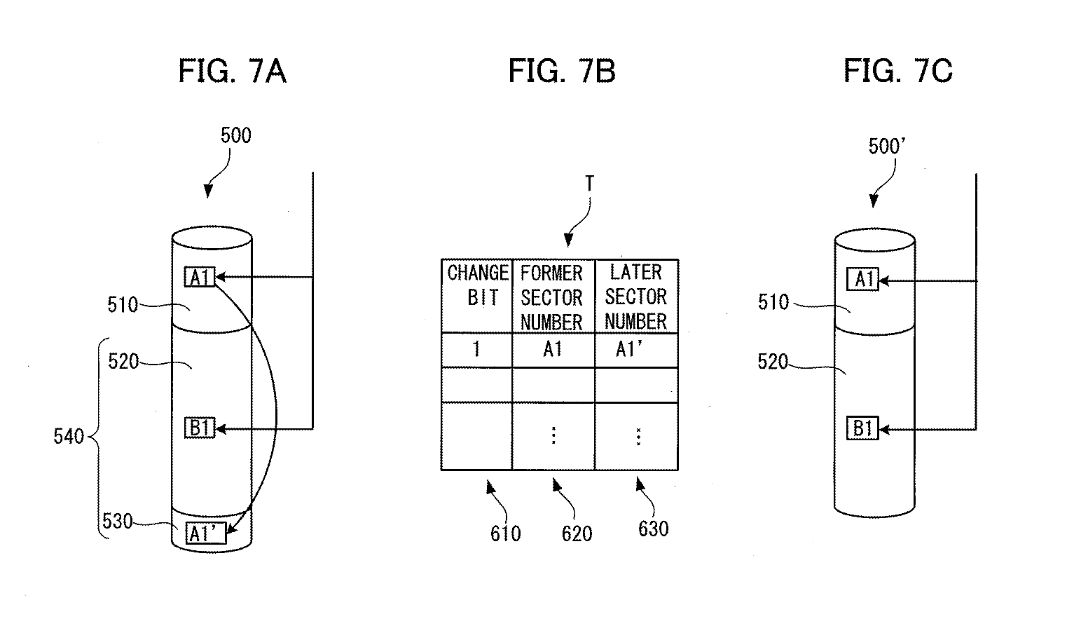

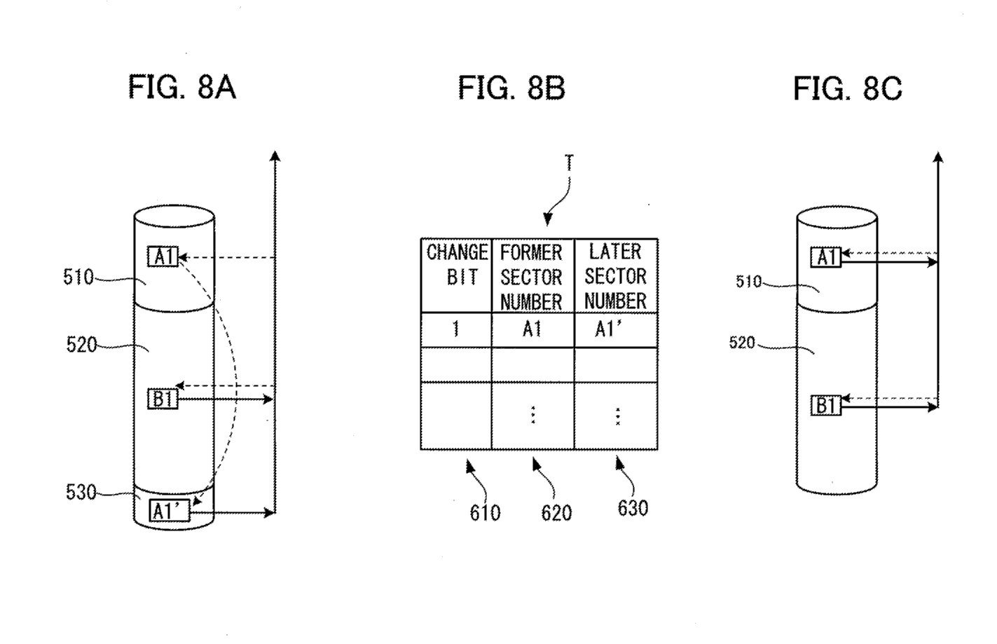

FIGS. 7A-7C are diagrams illustrating an outline of control at the time of data writing, and FIGS. 8A-8C are diagrams illustrating an outline of control at the time of data reading.

As illustrated in FIG. 7A, the control circuit board 250 divides a storage area 500 on the magnetic disk into a recovery data area 510, a new data area 520 and a modified data area 530, and manages these areas. The ranges of these areas 510-530 are defined by an area data D illustrated in FIG. 6. The recovery data area 510 stores data reproduced at the time of recovery, such as the factory-shipped OS program. The new data area 520 and the modified data area 530 form an incremental data area 540 that stores data representing increments produced after factory shipment. The new data area 520 stores new data, and the modified data area 530 stores data modified with respect to the recovery data area 510.

As illustrated in FIG. 7C, a visible area 500′ visible to the OS is formed by the recovery data area 510 and new data area 520. Therefore, the OS may designate, as a sector for writing and reading, a sector in the recovery data area 510 or a sector in the new data area 520.

When a command for writing data into a sector “B1” in the new data area 520 is issued from the OS to the HDD, the data is written in the sector “B1” according to the command. In contrast, when a command for writing data into a sector “A1” in the recovery data area 510 issued from the OS to the HDD, the following operation is performed. As illustrated in FIG. 7A, a sector “A1'” substituting the designated sector “A1” is prepared for in the modified data area 530. Subsequently, the data is written in the sector “A1'” serving as a substitute.

Also, as illustrated in FIG. 7B, sector management information that presents a correspondence between the designated sector “A1” and the sector “A1'” serving as the substitute is stored in a table T where sector management information is recorded, which is illustrated in FIG. 6. The table T includes a change bit column 610, a former sector-number column 620 and a later sector-number column 630. In the table T, the value in the change bit column 610 is “zero” for a part not in use, whereas the value in the change bit column 610 is “1” for a part in use. In other words, sector management information is recorded in the area where the value in the change bit column 610 of the table T is “1”. The number “A1” that represents the former sector in the recovery data area 510 is recorded in the former sector-number column 620. Further, the number “A1'” that represents a later sector prepared for in the modified data area 530 as a substitute of the former sector is recorded in the later sector-number column 630. Thus, the sector management information has a pair of the number of a former sector and the number of a later sector.

By controlling the writing of data in this way, it appears for the OS that the data is written in the sectors “A1” and “B1” targeted for writing in accordance with the command, as illustrated in FIG. 7C.

In reading of data, as illustrated in FIG. 8A, when a command designating the sector “B1” in the new data area 520 is issued, the data is read according to the command from the sector “B1”. When a command for reading data and designating the sector “A1” in the recovery data area 510 is issued, sector management information in the table T is referred to. In other words, a former sector whose number in the sector management information is “A1” is searched for, and the number “A1′” of the later sector corresponding to the found former sector is obtained. Subsequently, data is read from the later sector indicated with the number “A1'” and output to the OS.

According to the summary described with reference to FIGS. 7A-7C and FIGS. 8A-8C, even though the data in the recovery data area 510 is visible to the OS, modification and erasure are not carried out by commands from the OS. As a result, the factory-shipped data in the recovery data area 510 is maintained. When recovery is necessary, data stored in the incremental data area 540 formed by the new data area 520 and the modified data area 530 is erased, and recovery is implemented. In this recovery, copying and overwriting is not required. Copying and overwriting data requires a long processing time because it is necessary to actually write data into each sector. In contrast, in erasing data, although data in each sector remains as it is, the data is substantially erased by merely releasing the sector as a free area. Such a release is carried out in a short processing time. Therefore, according to the control described with reference to FIGS. 7A-7C and FIGS. 8A-8C, high-speed recovery is realized.

Now, the contents of the control by the control circuit board 250 will be described in detail, including the role of each function illustrated as the block in FIG. 6.

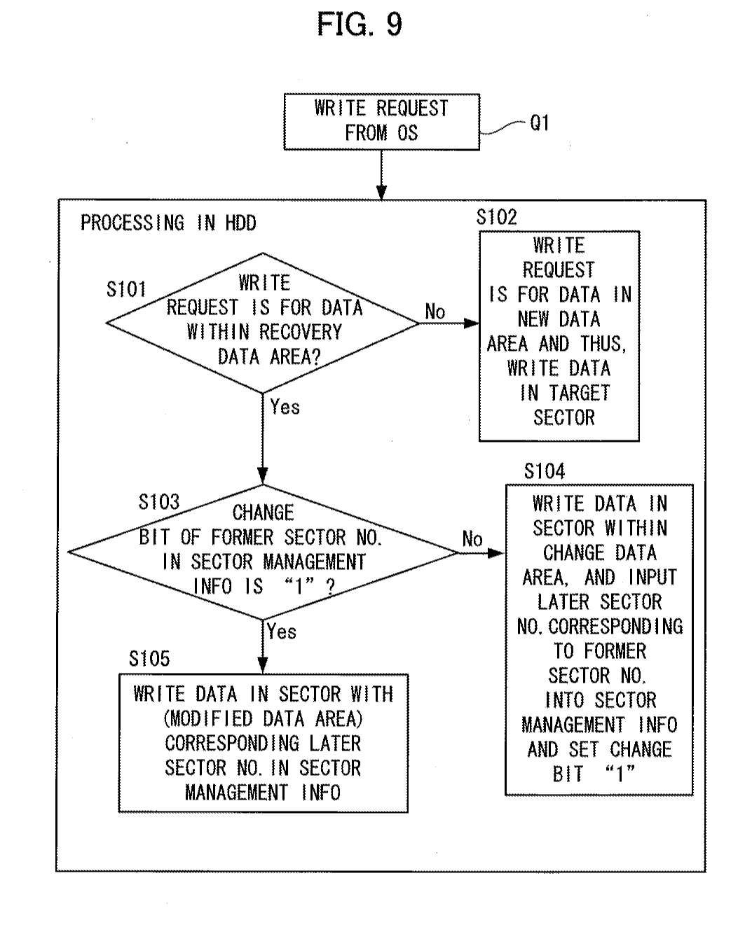

FIG. 9 is a flowchart illustrating the details of the contents of control at the time of data writing. Incidentally, in following description, the elements illustrated in FIG. 6 may be referred to without mentioning the figure number.

A write command (i.e. write request) Q1 issued by the OS is received by the command receiving section 410. Upon receipt of the write command, the command receiving section 410 refers to the area data D to check whether a sector designated by the command Q1 is a sector in a visible area. Specifically, the OS designates a sector by using a logical address. The area data D defines the visible area based on a range where physical addresses are assigned to logical addresses. When the logical address designated by the OS is outside the defined range of the visible area, the command receiving section 410 returns an error to the OS.

The command received by the command receiving section 410 is sent to the command distinguishing section 420. The command distinguishing section 420 refers to the area data D to check whether the sector designated by the command Q1 is within the recovery data area (step S101 in FIG. 9). When a sector out of the recovery data area (i.e. within the new data area) is designated by the command, the command is sent to the off-protection command control section 430. The off-protection command control section 430 controls the magnetic head and the actuator so that data is written in the designated sector (step S102 in FIG. 9). To describe the data writing carried out under the control of the off-protection command control section 430, a storage state of data at the time of factory shipment will be described.

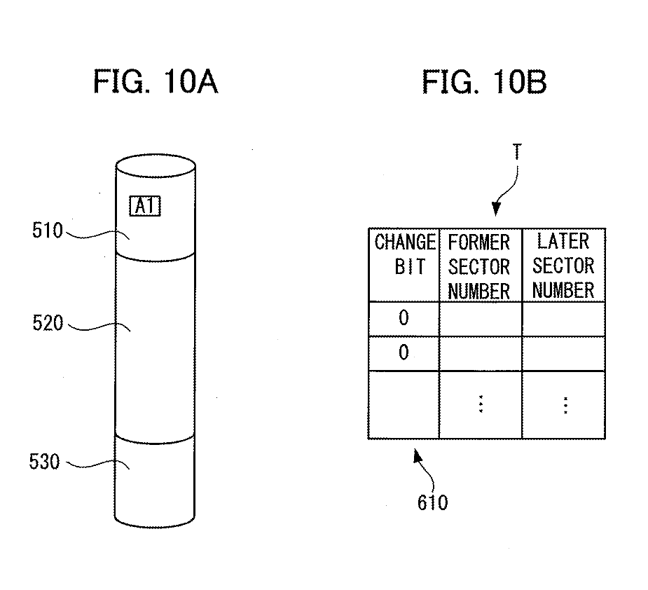

FIGS. 10A and 10B are diagrams that illustrate the storage state of data at the time of factory shipment.

As illustrated in FIG. 10A, data is stored only in the recovery data area 510 at the time of factory shipment. As an example, data is stored in the sector “A1” in FIG. 10A. The new data area 520 and the modified data area 530 are blank. Data stored in the recovery data area 510 includes data of the OS program and data of the file system.

As illustrated in FIG. 10B, in the table T where sector management information is recorded, all the values in the change bit column 610 are “zeros”. In other words, there is no record of sector management information in the table T.

The control by the off-protection command control section 430 will be described by taking, as an example, writing of data for the data in the factory-shipped state.

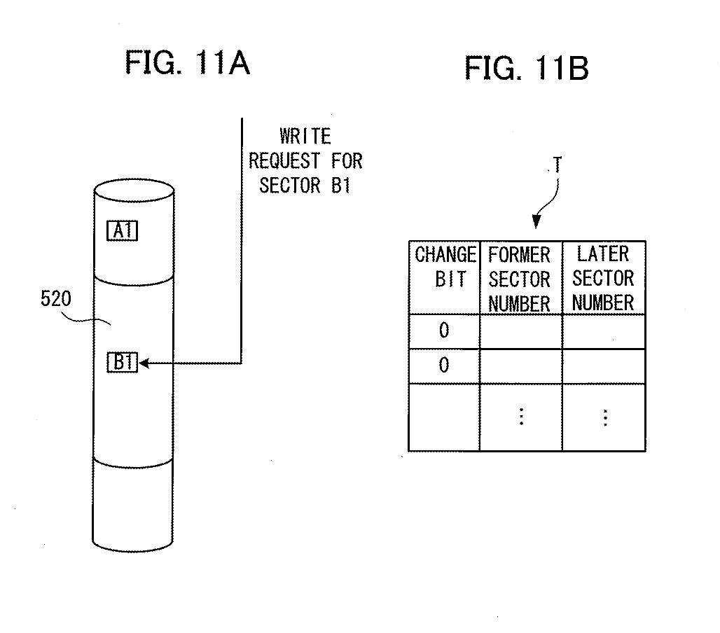

FIGS. 11A and 11B are diagrams that illustrate writing of data under the control of the off-protection command control section 430.

As described above, the off-protection command control section 430 controls the writing of data into the new data area 520. FIG. 11A illustrates, as an example, a state in which a command for writing into the sector “B1” is issued. The off-protection command control section 430 writes the data into the sector “B1” according to the command. Here, as illustrated in FIG. 11B, no record is made in the table T where sector management information is recorded, and the table T remains in the factory-shipped state.

Incidentally, when issuing a command for writing new data, the OS normally also issues a command for writing to update the file system. However, for convenience of explanation, an association between the commands is ignored here, and control of individual commands issued by the OS will be described.

Returning to FIG. 9, the description will be continued.

When it is determined that the command designates a sector within the recovery data area at step S101 in FIG. 9, the flow proceeds to step S103. In step S103, the within-protection writing control section 440 refers to each area (i.e. sector management information) where the value in the change bit column 610 is “1” in the table T. Subsequently, the within-protection writing control section 440 checks whether the former sector of each piece of sector management information matches the sector designated by the write command Q1.

When the sector designated by the write command Q1 and the former sector disagree with each other (step S103 in FIG. 9: No), it appears for the OS that the designated sector is in the factory-shipped state. Thus, the within-protection writing control section 440 prepares for a sector as a substitute in the modified data area. Subsequently, the within-protection writing control section 440 controls the magnetic head and the actuator so that the data is written into the sector serving as the substitute (step S104 in FIG. 9).

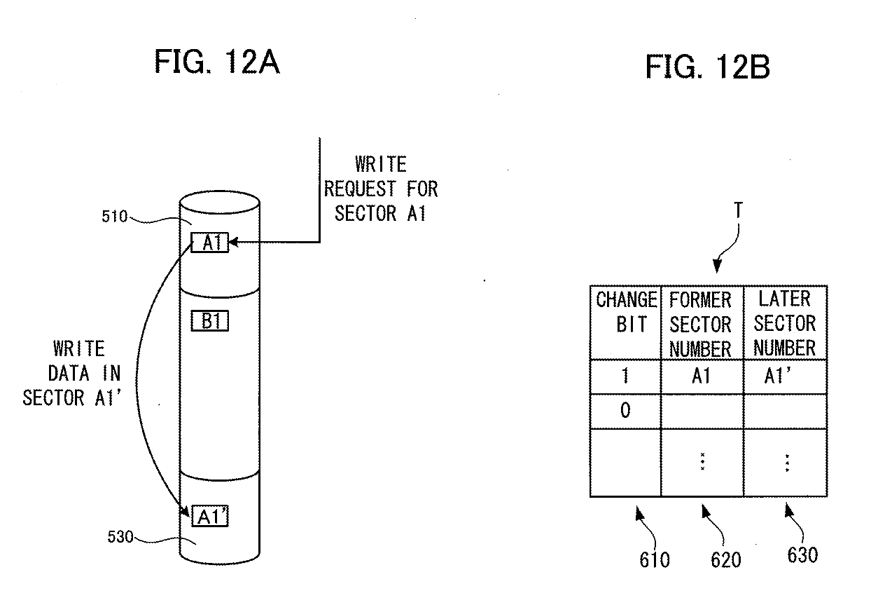

FIGS. 12A and 12B are diagrams that illustrate a state in which data is written for the data state illustrated in FIGS. 11A and 11B by the within-protection writing control section 440.

As illustrated in FIG. 12A, a write command from the OS designates the sector “A1” in the recovery data area 510. The within-protection writing control section 440 prepares for the sector “A1′” in the modified data area 530 as a substitute for this sector “A1”. Subsequently, the within-protection writing control section 440 writes the data into the substitute “A1′”. Also, the within-protection writing control section 440 records the sector management information in the table T as illustrated FIG. 12B. Specifically, at first, an unassigned area whose value in the change bit column 610 is “zero” is found among the rows of the table T. Subsequently, the value “1” is written in the change bit column 610 corresponding to the found unassigned area. Further, the number “A1” of the former sector is written in the former sector-number column 620. Furthermore, the number “A1” of the former sector is written in the later sector-number column 630.

Returning to FIG. 9, the description will be continued.

In step S103 in FIG. 9, when the sector designated by the write command and the former sector agree with each other (step S103 in FIG. 9: Yes), a sector that substitutes the designated sector has been already prepared for in the modified data area. In this case, the within-protection writing control section 440 controls the magnetic head and the actuator so that the data is written in the substituting sector (step S105 in FIG. 9). In other words, as illustrated in FIG. 12B, the sector management information has been already recorded in the table T. In the former sector-number column 620 of a point whose value in the change bit column 610 is “1”, the former sector having the same number “A1” as the sector “A1” designated by the command has been recorded. Thus, the within-protection writing control section 440 obtains the number “A1′” of the later sector corresponding to the former sector. Subsequently, the within-protection writing control section 440 controls the magnetic head and the actuator so that the magnetic head and the actuator carry out overwriting of data in the sector “A1′” in the modified data area 530 indicated by the obtained number “A1′”.

Next, the contents of the control at the time of data reading by the control circuit board 250 will be described in detail.

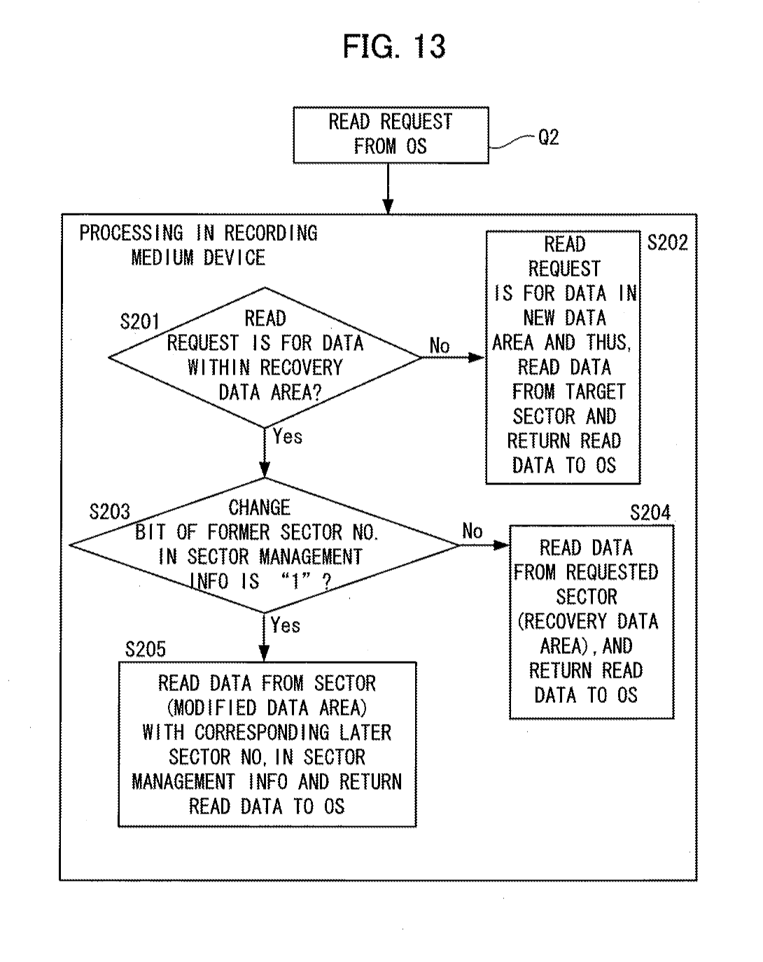

FIG. 13 is a flowchart illustrating the details of the contents of the control at the time of data reading.

A read command (i.e. read request) Q2 issued by the OS is received by the command receiving section 410. The command Q2 received by the command receiving section 410 is sent to the command distinguishing section 420. The command distinguishing section 420 refers to the area data D to check whether the sector designated by the command Q2 is within the recovery data area (step S201 in FIG. 13). When the command designates a sector out of the recovery data area (i.e. within the new data area), the command is sent to the off-protection command control section 430. The off-protection command control section 430 controls the magnetic head and the actuator so that the data is read from the designated sector (step S202 in FIG. 13). Here, there will be described an example in which the off-protection command control section 430 carries out data reading for the data state illustrated in FIGS. 12A and 12B.

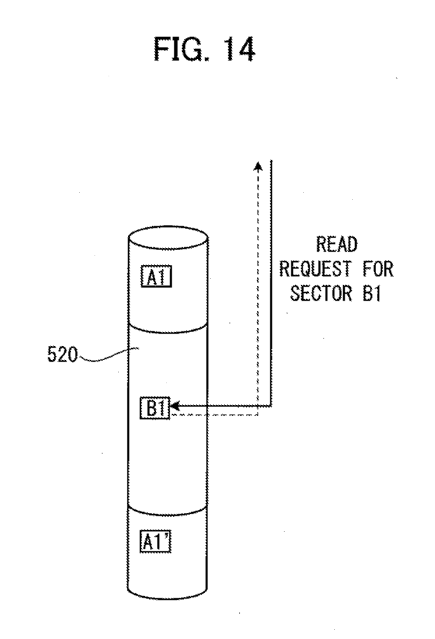

FIG. 14 is a diagram illustrating data reading under the control of the off-protection command control section 430.

In this example, the read command from the OS designates the sector “B1” in the new data area 520. The off-protection command control section 430 controls the magnetic head and the actuator so that the data is read from the designated sector “B1”.

Returning to FIG. 13, the description will be continued.

When it is determined that the command is a command that designates a sector within the recovery data area at step S201 in FIG. 13, the flow proceeds to step S203. In step S203, the within-protection reading control section 450 refers to each point (i.e. sector management information) where the value in the change bit column 610 is “1” in the table T. Subsequently, the within-protection reading control section 450 checks whether the former sector of each piece of sector management information matches the sector designated by the read command Q2.

When the sector designated by the read command Q2 and the former sector disagree with each other (step S203 in FIG. 13: No), it appears for the OS that the designated sector is in the factory-shipped state. Thus, the within-protection reading control section 450 controls the magnetic head and the actuator so that the data is read from the designated sector in the recovery data area (step S204 in FIG. 13). This control will be described by taking, as example, reading data in the state illustrated in FIGS. 10A and 10B.

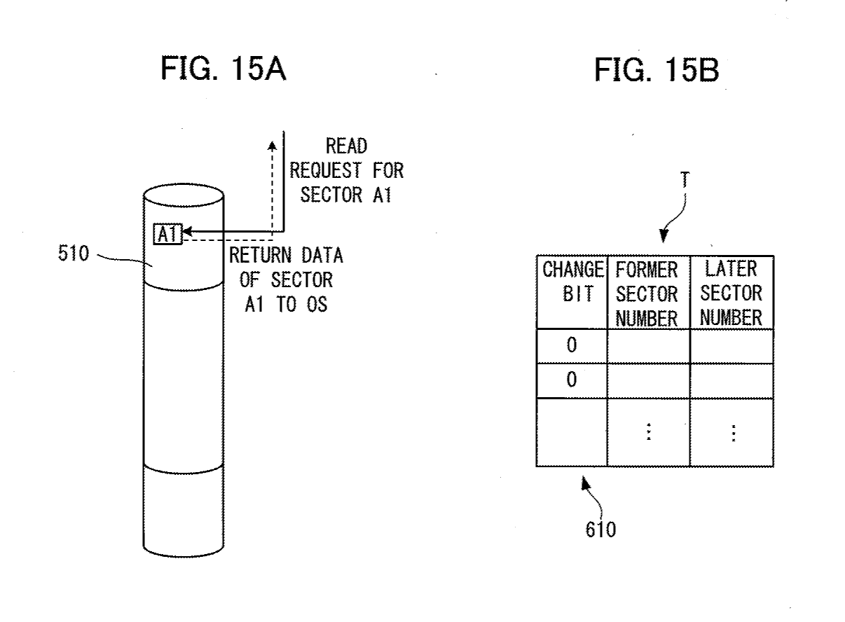

FIGS. 15A and 15B are diagrams that illustrate a state in which the data in the state illustrated in FIGS. 10A and 10B is read under the control of the within-protection reading control section 450.

In this example, as illustrated in FIG. 15A, a read command from the OS designates the sector “A1” in the recovery data area 510. The within-protection reading control section 450 refers to the table T, and searches for the sector management information having the designated sector “A1” as a former sector. However, as illustrated in FIG. 15B, any of the values in the change bit column 610 of the table T is “zero”. Thus, the sector management information is not recorded in the table T. Then, the within-protection reading control section 450 controls the magnetic head and the actuator so that the magnetic head and the actuator access and read data from the sector “A1” designated by the command.

Returning to FIG. 13, the description will be continued.

In step S203 in FIG. 13, when the sector designated by the read command and the former sector agree with each other (step S203 in FIG. 13: Yes), actual data has been recorded in a sector that substitutes the designated sector. In this case, the within-protection reading control section 450 controls the magnetic head and the actuator so that the data is read from the substituting sector (step S205 in FIG. 13). This control will be described by taking, as example, reading data in the state illustrated in FIGS. 12A and 12B.

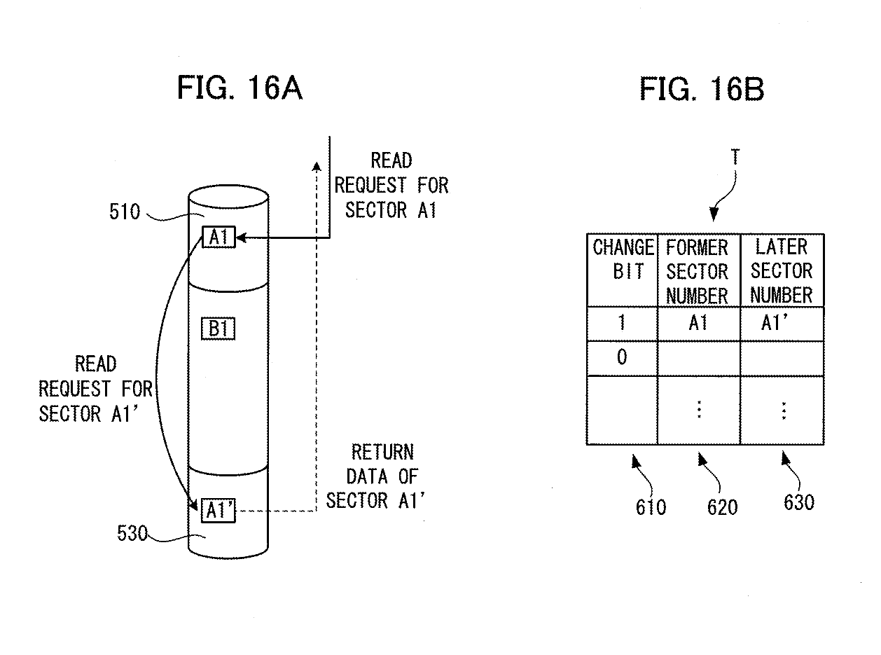

FIGS. 16A and 16B are diagrams that illustrate a state in which data in the state illustrated in FIG. 12A and 12B is read under the control of the within-protection reading control section 450.

As illustrated in FIG. 16A, the read command from the OS designates the sector “A1” in the recovery data area 510 in this example as well. The within-protection reading control section 450 refers to the table T, and searches for sector management information having the designated sector “A1” as a former sector. As illustrated in FIG. 16B, a former sector of the number “A1” that is the same as the sector “A1” designated by the command is recorded in the former sector-number column 620 for a point whose value in the change bit column 610 is “1”. Thus, the within-protection reading control section 450 obtains the number “A1′” of the later sector corresponding to the former sector. Subsequently, the within-protection reading control section 450 controls the magnetic head and the actuator so that the data is read from the sector “A1′” in the modified data area 530 indicated by the number “A1′”.

The data in the recovery data area 510 is always saved by carrying out the above-described control for writing and control for reading. Also, it appears for the OS that writing and reading is executed for the sector designated by the OS, including those in the recovery data area 510.

Finally, the function of the recovery section 460 illustrated in FIG. 6 will be described.

Other than the write command and read command, the command receiving section 410 illustrated in FIG. 6 receives a recovery command issued by the OS to order a recovery. The recovery command received by the command receiving section 410 is sent to the recovery section 460. Upon receipt of the recovery command, the recovery section 460 erases sector management information recorded in the table T. Specifically, all the values in the change bit column 610 of the table T are replaced with “zeros”. As a result, all the write commands for the data in the recovery data area 510 are canceled. In other words, the data in the modified data area 530 is substantially erased. For the OS, the data in the recovery data area 510 appears to be in the factory-shipped state. Also, as described above, the file system is included in the data in the recovery data area 510. When the file system returns to the factory-shipped state, the data written in the new data area 520 also is substantially erased. After all, in the HDD 200 illustrated in FIG. 4, the data in both the new data area 520 and the modified data area 530 is substantially erased by merely rewriting a part of the table T in the control circuit board 250. In other words, not only overwriting with the recovery data on the magnetic disk 210 but also access to the magnetic disk 210 is not required at all. Therefore, high-speed recovery is realized in the HDD 200.

This concludes the description of the first embodiment, and a second embodiment will be now described. Incidentally, the second embodiment is different from the first embodiment in that software executed inside the control circuit board 250 illustrated in FIG. 4 is different from that in the first embodiment, while the first and second embodiments are completely the same in terms of hardware. Thus, in the following description of the second embodiment, when illustration of hardware is necessary, the drawings that illustrate the first embodiment will be used as those illustrating the second embodiment.

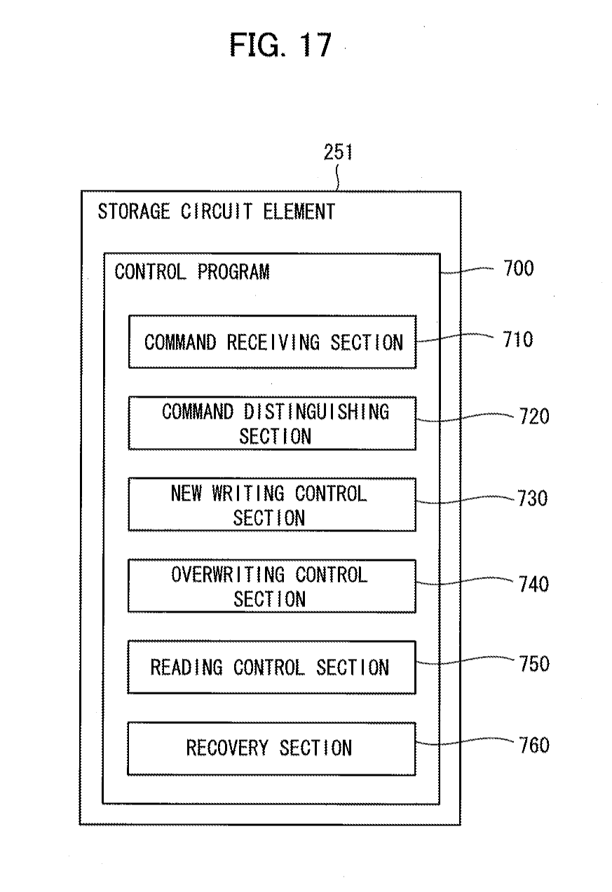

FIG. 17 is a diagram that illustrates a control program 700 stored in the storage circuit element 251 according to the second embodiment.

The control program 700 is stored in the storage circuit element 251 as in the first embodiment. The control program 700 includes a command receiving section 710 and a command distinguishing section 720. The control program 700 further includes a new writing control section 730, an overwriting control section 740, a reading control section 750 and a recovery section 760. When the control program 700 is executed by the processing circuit element 252, the control circuit board 250 serves as an example of an access control device.

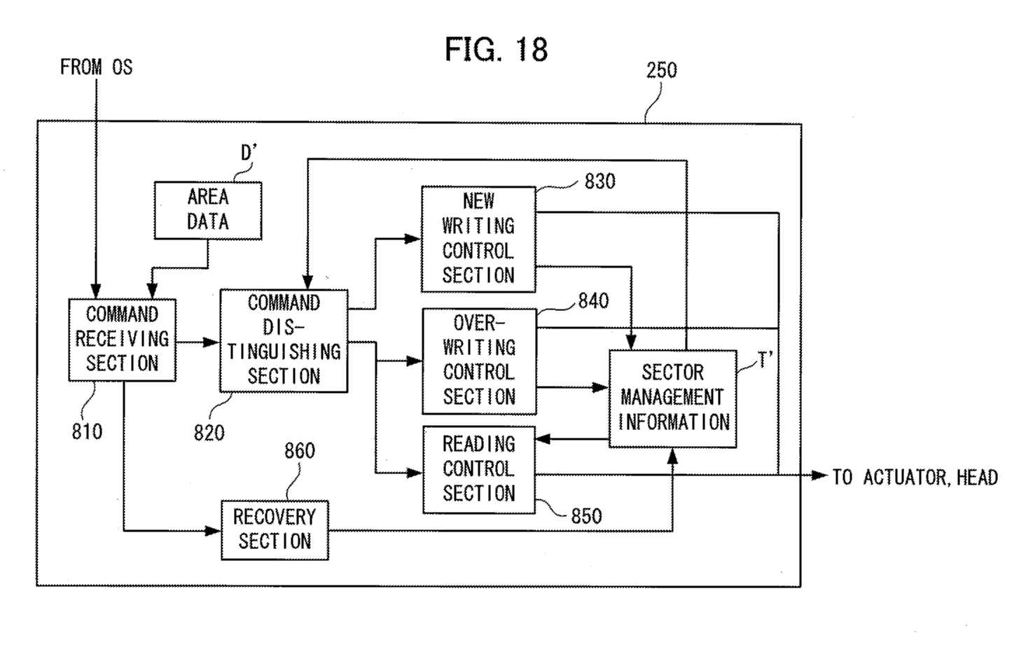

FIG. 18 is a functional block diagram that illustrates the function of the control circuit board 251 in the second embodiment.

When the control program 700 illustrated in FIG. 17 is executed, the control circuit board 250 serves as a command receiving section 810 and a command distinguishing section 820 each indicated with a block in FIG. 18. Further, the control circuit board 250 serves as a new writing control section 830, an overwriting control section 840, a reading control section 850 and a recovery section 860. The command receiving section 810 of the control circuit board 250 illustrated in FIG. 18 is a function realized by the command receiving section 710 of the control program 700 illustrated in FIG. 17. Similarly, the command distinguishing section 820 through the recovery section 860 illustrated in FIG. 18 are functions realized by the command distinguishing section 720 through the recovery section 760 illustrated in FIG. 17, respectively.

Now, these functions will be described in detail. In the following description, the elements illustrated in FIG. 18 will be used without mentioning the figure number.

A command issued by the OS is received by the command receiving section 810. As in the first embodiment, upon receipt of the command, the command receiving section 810 refers to an area data D′ to check whether a sector designated by the command is in a visible area. When the logical address designated by the OS is out of the definition range of the visible area represented by the area data D′, the command receiving section 810 returns an error to the OS.

The command received by the command receiving section 810 is sent to the command distinguishing section 820. Subsequently, unlike the first embodiment, the command distinguishing section 820 refers to sector management information recorded in a table T′. In the second embodiment, a protected area is defined by the sector management information. In other words, all the sectors with sector management information recorded in table T′ are treated as a protected area, and data will not be erased unless recovery is performed.

Here, the table T′ used in the second embodiment will be described.

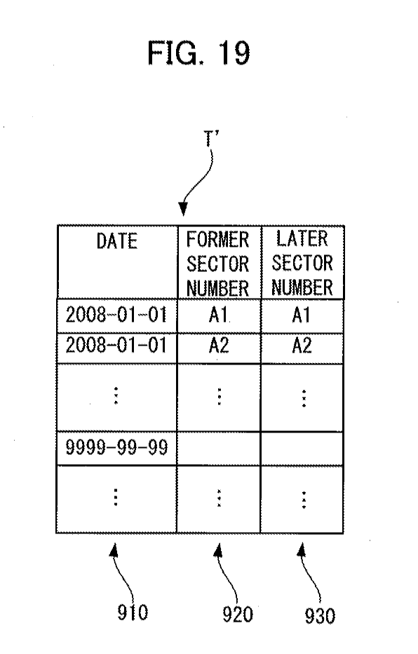

FIG. 19 is a diagram illustrating the table T′ used in the second embodiment.

The table T′ illustrated in FIG. 19 is a table at the time of factory shipment (Jan. 1, 2008 in this example). The table T′ includes a date column 910, a former sector-number column 920 and a later sector-number column 930. In the second embodiment, sector management information has been already recorded in the table T′ at the time of factory shipment. Note that the sector management information recorded at the time of factory shipment (i.e. sector management information whose value in the date column 910 is “2008-01-01”) has the same numbers in the former sector-number column 920 and the later sector-number column 930. Such sector management information having the same numbers recorded as a former sector and a later sector may not be substantially regarded as sector management information. Nevertheless, even if the same numbers are recorded as a former sector and a later sector, the sector management information with these same numbers is one type of sector management information in terms of form. In contrast, a point with a value in the date column 910 of the table T′ is “9999-99-99” is not used, because this point does not satisfy the form of the sector management information.

The sectors stored as formal sector management information at the time of factory shipment in the table T′ correspond to the recovery data area in the first embodiment. In other words, the sectors where the OS program and the data of the file system have been already stored at the time of factory shipment are stored in the table T′ as formal sector management information. Sector management information is sequentially added to the table T′, which will be described later. With the addition of the sector management information, the number of sectors which the command distinguishing section 820 recognizes as the protected area is increased.

Now, the control of writing and reading of data using the table T′ will be described.

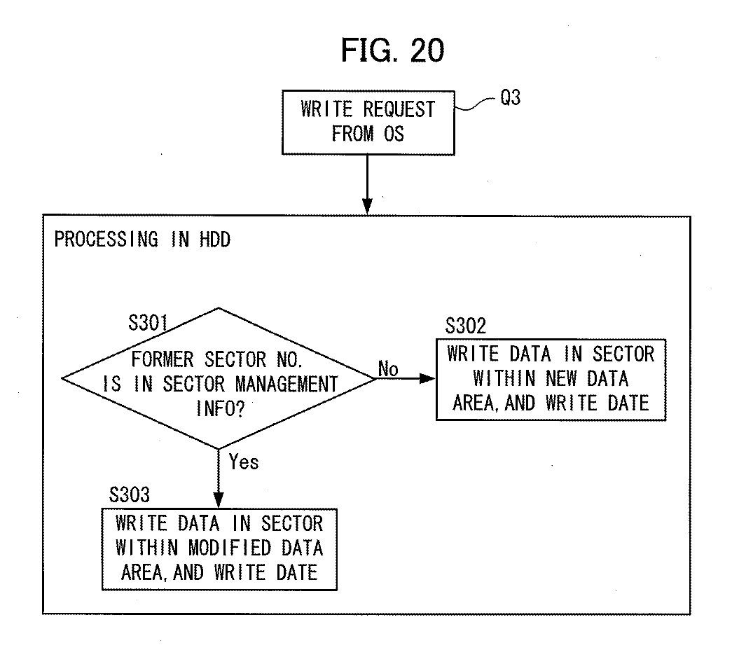

FIG. 20 is a flowchart presenting the data writing control by the control circuit board 250 illustrated in FIG. 18.

A write command (i.e. write request) Q3 from the OS illustrated in FIG. 20 is received by the command receiving section 810 and sent to the command distinguishing section 820 as described above. Subsequently, the command distinguishing section 820 refers to the table T′ and searches for sector management information having the sector designated by the write command Q3 as a former sector (step S301 in FIG. 20). When such sector management information is not found, the write command Q3 is regarded as a command that orders writing of data in the new data area. In that case, the new writing control section 830 controls the magnetic head and the actuator so that the data is written in the sector designated by the command (step S302 in FIG. 20). Further, the new writing control section 830 records, in the table T′, sector management information having the designated sector as a former sector and a later sector. In the date column 910 for the sector management information, the date when the data was written is recorded.

On the other hand, when the sector management information having the sector designated by the write command Q3 as a former sector is found in step S301, the write command Q3 is regarded as a command that orders overwriting of data that has been already stored. In that case, the overwriting control section 840 prepares for a new alternative sector in the modified data area that is invisible to the OS. Subsequently, the overwriting control section 840 controls the magnetic head and the actuator so that the data is written in the alternative sector (step S303 in FIG. 20).

The data writing is controlled by the control circuit board 250 illustrated in FIG. 18 in this way.

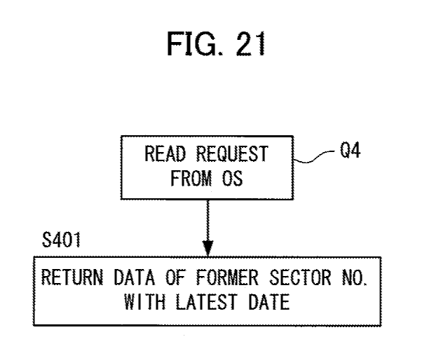

FIG. 21 is a flowchart presenting the data reading control by the control circuit board 250 illustrated in FIG. 18.

A read command (i.e. read request) Q4 from the OS illustrated in FIG. 20 is received by the command receiving section 810 and sent to the command distinguishing section 820 as described above. The command distinguishing section 820 sends the read command directly to the reading control section 850. In the second embodiment, since all the areas where data has been written serve as a protected area, reading of data from an area outside the protected area does not occur. Subsequently, the reading control section 850 refers to the table T′ and searches for sector management information having the designated sector of the read command Q4 as a former sector. From the found pieces of sector management information, the reading control section 850 obtains the number of a later sector included in the piece of sector management information with the latest date. The reading control section 850 controls the magnetic head and the actuator so that the data is read from the sector indicated by the obtained number (step S401).

As described above, the control of data writing and data reading in the second embodiment is simpler than the control in the first embodiment.

The recovery section 860 illustrated in FIG. 18 replaces the value in the date column 910 of the table T′ for the sector management information with “9999-99-99”, thereby implementing the recovery of data in the second embodiment. In the second embodiment as well, the command receiving section 810 receives, from the OS, a recovery command for ordering a recovery. In the second embodiment however, the recovery command designates the date of data whose recovery is desired. Upon receipt of the recovery command, the command receiving section 810 sends the date designated by the recovery command to the recovery section 860. The recovery section 860 checks the value recorded in the date column 910 of the table T′ where sector management information is stored. Subsequently, among the values recorded in the date column 910, the recovery section 860 replaces all the values that show dates later than the assigned date with a value “9999-99-99”. By this process, the data is substantially returned to the state dated earlier than the designated date.

Now, using a specific example, data writing, data reading and recovery in the second embodiment will be described.

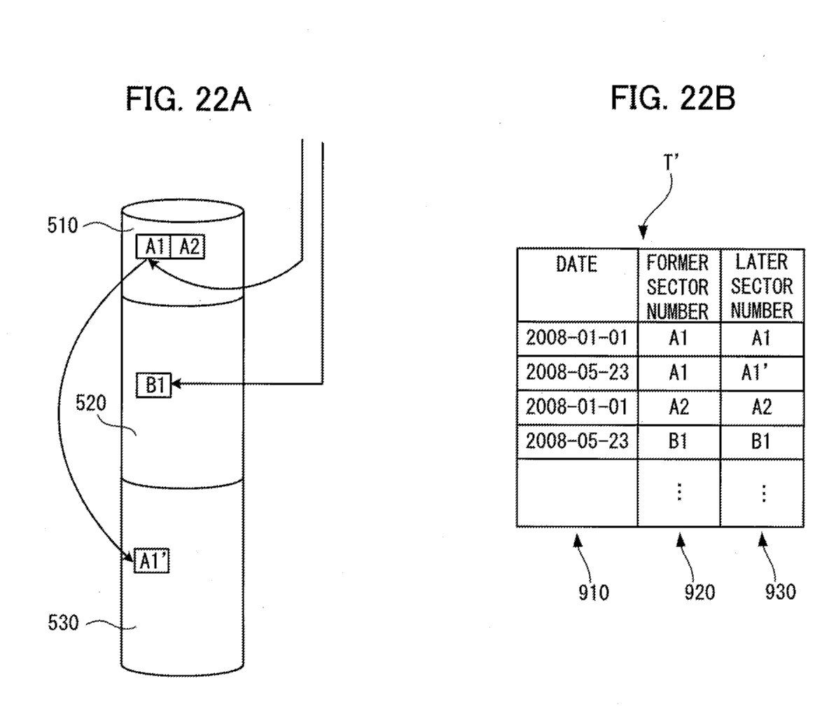

FIGS. 22A and 22B are diagrams that illustrate a state in which data has been added for the first time after factory shipment.

As illustrated in FIG. 22A, data is stored at the time of factory shipment dated Jan. 1, 2008 in the two sectors “A1” and “A2” in the recovery data area 510. Incidentally, the recovery data area 510 is defined by sector management information dated Jan. 1, 2008 stored in the table T′ illustrated in FIG. 22B.

Also, as illustrated in FIG. 22A, on May 23, 2008, a write command that designates the sector “A1” in the recovery data area 510 and a write command that designates the sector “B1” in the new data area 520 are issued. The write command that designates the sector “A1” in the recovery data area 510 is a command for ordering overwriting of data. In contrast, the write command that designates the sector “B1” in the new data area 520 is a command for ordering writing of new data. When these commands are executed, two pieces of sector management information each having a value of “2008-05-23” in the date column 910 are added to the table T′ illustrated in FIG. 22B. One of these pieces of information is sector management information of which the number “A1” of the sector in the recovery data area 510 is recorded in the former sector-number column 920 and the number “A1′” of the sector in the modified data area 530 is recorded in the later sector-number column 930. The other is sector management information of which the number “B1” of the sector in the new data area 520 is recorded in both the later sector-number column 930 and the former sector-number column 920. Incidentally, here, pieces of sector management information having a common former sector are listed in the table T′ as a group for easy understanding. Actually however, pieces of sector management information are recorded in the table T′ in order of date.

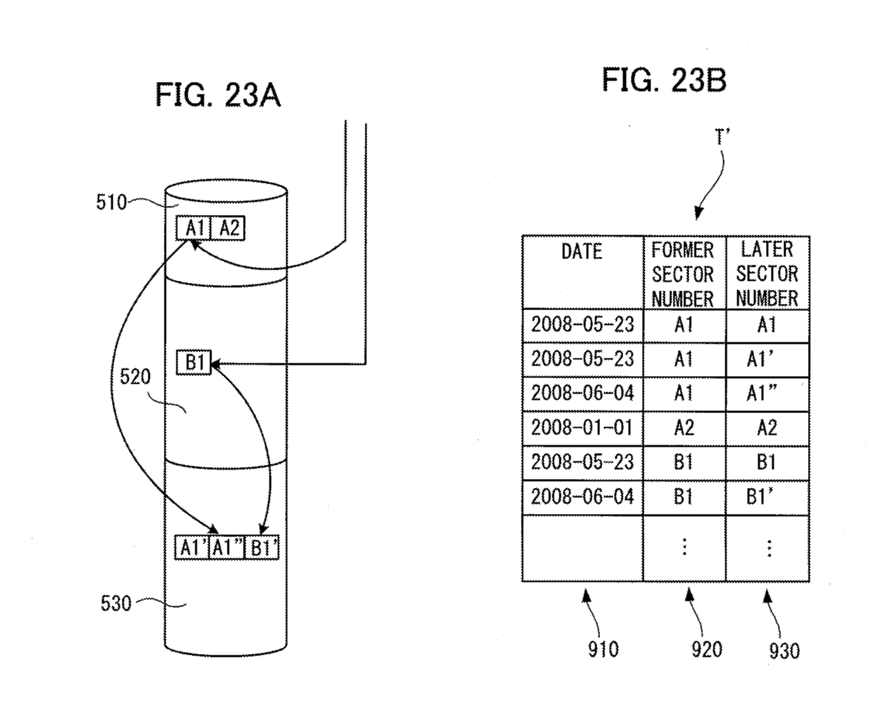

FIGS. 23A and 23B are diagrams that illustrate a state in which data is further added after the state illustrated in FIG. 22A and 22B.

On Jun. 4, 2008, a write command that designates the sector “A1” in the recovery data area 510 and a write command that designates the sector “B1” in the new data area 520 are issued as illustrated in FIG. 22A. In the example illustrated in FIGS. 23A and 23B, these commands both indicate overwriting of data. When these commands are executed, two pieces of sector management information each having a value of “2008-06-04” in the date column 910 are added to the table T′ as illustrated in FIG. 23B. One of these pieces of information is sector management information of which the number “A1” of the sector in the recovery data area 510 is recorded in the former sector-number column 920 and the number “A1″” of the sector in the modified data area 530 is recorded in the later sector-number column 930. The other is sector management information of which the number “B1” of the sector in the new data area 520 is recorded in the former sector-number column 920 and the number “B1′” of the sector in the modified data area 530 is recorded in the later sector-number column 930.

In this way, no data is actually overwritten in the second embodiment. However, it appears for the OS that overwriting is executed.

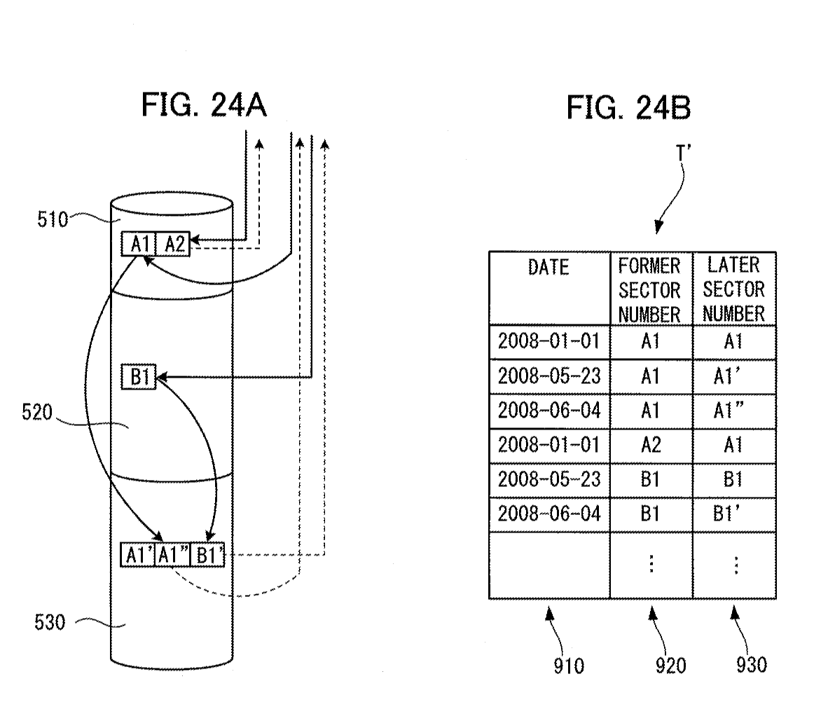

FIGS. 24A and 24B are diagrams that illustrate a state in which reading of data in the state illustrated in FIG. 23 is executed.

Here, three commands for ordering data reading are issued as illustrated in FIG. 24A. Specifically, two commands that designate the sectors “A1” and “A2” in the recovery data area 510 and one command that designates the sector “B1” in the new data area 520 are issued. For each of these commands, the table T′ illustrated in FIG. 24B is referred to in order to check a sector from which data is to be actually read. In the table T′, there are three pieces of sector management information each having “A1” in the former sector-number column 920. Among these three pieces of sector management information, one whose value in the date column 910 is “2008-06-04” corresponding to the latest date is found. Data is read from the sector “A1″” represented by the number “A1″” of the later sector recorded in the later sector-number column 930. Further, there is only one piece of sector management information whose number in the former sector-number column 920 is “A2” in the table T′. Data is read from the sector “A2” represented by the number “A2” of the later sector recorded in the later sector-number column 930. Furthermore, there are two pieces of sector management information each having “B1” as the number in the former sector-number column 920 in the table T′. Between these two pieces of sector management information, one whose value in the date column 910 is “2008-06-04” corresponding to the latest date is found. Data is read from the sector “B1′” represented by the number “B1′” of the later sector recorded in the later sector-number column 930. In this way, even when there are actually two or three layered pieces of data, it appears for the OS that only the data with the latest date is stored.

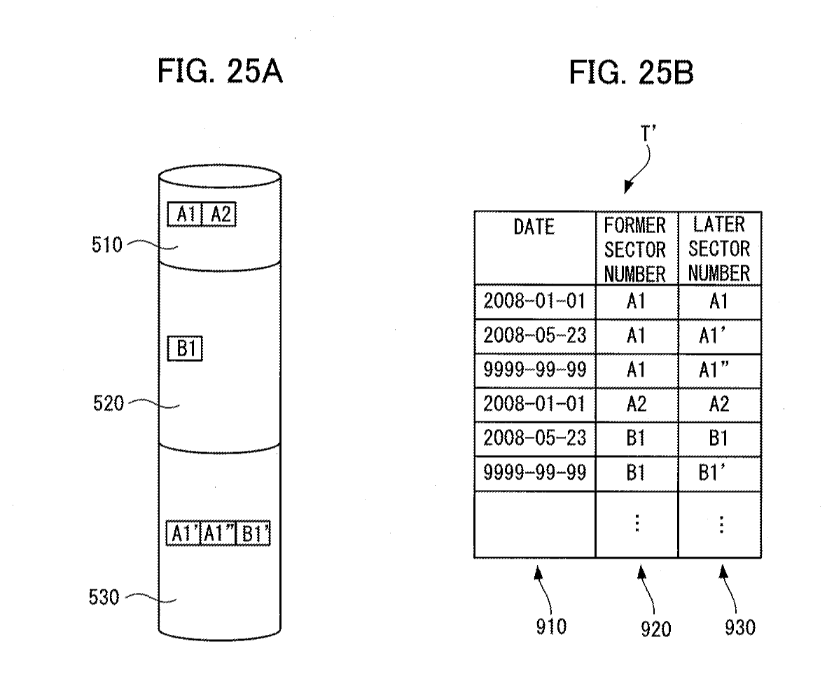

FIGS. 25A and 25B are diagrams that illustrate a state in which recovery of the data in the state illustrated in FIGS. 24A and 24B is executed.

In this example, the date designated by a recovery command is May 23, 2008. As illustrated in FIG. 25B, among values in the date column 910 of the table T′, a value with the date later than May 23, 2008 is replaced with “9999-99-99”.

At the time, as illustrated in FIG. 25A, the data stored in the recovery data area 510, the data stored in the new data area 520, and the data stored in the modified data area 530 are not changed at all. Also, as illustrated in FIG. 25B, the record in the former sector-number column 920 and the record in the later sector-number column 930 of the table T′ also are not changed at all. Nevertheless, by merely replacing a part of the values in the date column 910 with “9999-99-99”, recovery of the data is realized.

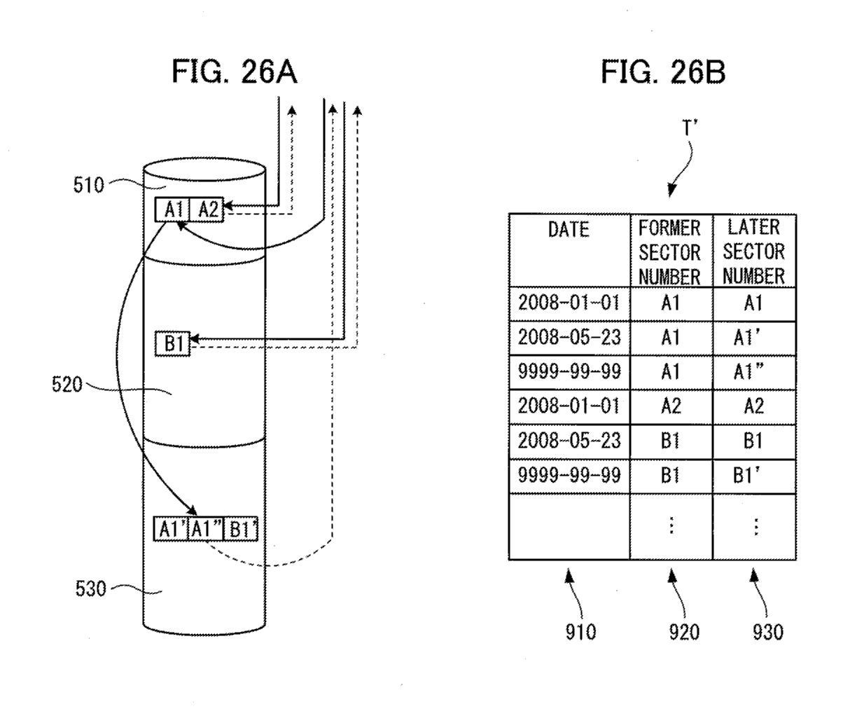

FIGS. 26A and 26B are diagrams that illustrate a state in which reading of the data in the state illustrated in FIGS. 25A and 25B is executed.

As in the calling of data illustrated in FIGS. 24A and 24B, three commands for ordering data reading are issued as illustrated in FIG. 26A. Specifically, there are two commands that designate the sector “A1” and “A2” in the recovery data area 510 and one command that designates the sector “B1” in the new data area 520. For each of these commands, the table T′ illustrated in FIG. 26B is referred to in order to check a sector from which data is to be actually read.

There are three “A1” in the former sector-number column 920. Substantially however, “A1” in the row where the value in the date column 910 is “9999-99-99” is erased. Thus, in the table T′, there are two pieces of sector management information each having “A1” as the value in the former sector-number column 920. Subsequently, of the two pieces of sector management information, one whose value in the date column 910 is “2008-05-23” corresponding to the latest date is found. Data is read from the sector “A1′” represented by the number “A1′” of the later sector recorded in the later sector-number column 930. Further, in the table T′, there is only one piece of sector management information whose number in the former sector-number column 920 is “A2”. Data is read from the sector “A2” represented by the number “A2” of the later sector recorded in the later sector-number column 930. Furthermore, there are two “B1” in the former sector-number column 920. Substantially however, “B1” in the row where a value in the date column 910 is “9999-99-99” has been erased. Thus, in the table T′, there is only one piece of sector management information whose number in the former sector-number column 920 is “B1” . Data is read from the sector “B1” represented by the number “B1” of the later sector recorded in the later sector-number column 930.

In this way, even when real data remains in the storage area, it appears for the OS that a data state dated in the past is recovered. In other words, when the recovery section 860 illustrated in FIG. 18 merely renews a part of record in the table T′ within the control circuit board 250, recovery is executed. Thus, high-speed recovery is realized. Besides, by designating a date in the recovery command, the data at an arbitrary point of time is recovered.

This concludes the description of the second embodiment.

Incidentally, in the above description, the personal computer is employed as a specific embodiment of the electronic apparatus. However, the electronic apparatus may be applied to a surveillance camera with a pre-installed program.

Further, in the above description, the HDD is illustrated as a specific embodiment of the storage device. However, the storage device may be applied to, for example, a semiconductor memory and an optical disk drive. In applications of those other than the HDD, an access section different from the magnetic head described above may be used, such as an access circuit that accesses the storage area of the semiconductor memory and an optical head that accesses the optical disk.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage device, comprising:
an access section that performs data access to a storage area where data is stored;
a command receiving section that receives a command including designation of an access point within the storage area and designation of data access to the access point, the command receiving section being capable of accepting designation of a point in a visible area defined within the storage area as the access point, while being incapable of accepting designation of a point in an invisible area except for the visible area as the access point;
a command distinguishing section that distinguishes whether the command received by the command receiving section is a within-protection command that designates an access point within a protected area defined in the visible area or an off-protection command that designates an access point outside the protected area in the visible area;
an off-protection command control section that causes the access section to perform data access to the access point designated by the off-protection command;
a within-protection writing control section that causes, when data writing is designated as the data access by the within-protection command, the access section to write data at an alternative point in the invisible area, and records a correspondence between the access point designated by the within-protection command and the alternative point; and
a within-protection reading control section that searches for and finds, when data reading is designated as the data access by the within-protection command, the alternative point corresponding to the access point designated by the within-protection command based on the recorded correspondence, and causes the access section to read data from the found alternative point.

2. The storage device according to claim 1, further comprising a recovery section that erases data stored outside the protected area among the data stored in the storage area.

3. The storage device according to claim 2, wherein the within-protection writing control section records the correspondence in a correspondence table, and
the recovery section substantially erases the data stored outside the protected area by erasing the correspondence recorded in the correspondence table.

4. The storage device according to claim 2, wherein the within-protection writing control section records the correspondence in a correspondence table together with a data written date,
the correspondence table records the correspondence between the access point and the alternative point, and also records a storage point of data stored within the protected area, in the same recording form as a recording form of the correspondence, as a correspondence in which both the access point and the alternative point are at an identical storage point,
the protected area is defined by a group of access points recorded in the correspondence table and increases by accumulating data every time data is written, and
the recovery section erases, in response to designation of a date, a correspondence with a data later than the designated data among correspondences recorded in the correspondence table, thereby substantially erasing data outside the protected area in the past.

5. An access control device, comprising:
a command receiving section that receives a command including designation of an access point within a storage area where data is stored and designation of data access to the access point, the command receiving section being capable of accepting designation of a point in a visible area defined within the storage area as the access point, while being incapable of accepting designation of a point in an invisible area except for the visible area as the access point;
a command distinguishing section that distinguishes whether the command received by the command receiving section is a within-protection command that designates an access point within a protected area defined in the visible area or an off-protection command that designates an access point outside the protected area in the visible area;
an off-protection command control section that causes an access section that performs data access to the storage area to perform data access to the access point designated by the off-protection command;
a within-protection writing control section that causes, when data writing is designated as the data access by the within-protection command, the access section to write data at an alternative point in the invisible area, and records a correspondence between the access point designated by the within-protection command and the alternative point; and
a within-protection reading control section that searches for and finds, when data reading is designated as the data access by the within-protection command, the alternative point corresponding to the access point designated by the within-protection command based on the recorded correspondence, and causes the access section to read data from the found alternative point.

6. The access control device according to claim 5, further comprising a recovery section that erases data stored outside the protected area among the data stored in the storage area.

7. The access control device according to claim 6, wherein the within-protection writing control section records the correspondence in a correspondence table, and
the recovery section substantially erases the data stored outside the protected area by erasing the correspondence recorded in the correspondence table.

8. The access control device according to claim 6, wherein the within-protection writing control section records the correspondence in a correspondence table together with a data written date,
the correspondence table records the correspondence between the access point and the alternative point, and also records a storage point of data stored within the protected area, in the same recording form as a recording form of the correspondence, as a correspondence in which both the access point and the alternative point are at an identical storage point,
the protected area is defined by a group of access points recorded in the correspondence table and increases by accumulating data every time data is written, and the recovery section erases, in response to designation of a date, a correspondence with a data later than the designated data among correspondences recorded in the correspondence table, thereby substantially erasing data outside the protected area in the past.

9. An electronic apparatus, comprising:
an information processing section that executes information processing according to program data stored in a storage area where data is stored, and issues, during information processing, a command including designation of an access point within the storage area and designation of data access to the access point;
an access section that performs data access to the storage area;
a command receiving section that receives the command issued by the information processing section, and the command receiving section being capable of accepting designation of a point in a visible area defined within the storage area as the access point, while being incapable of accepting designation of a point in an invisible area except for the visible area as the access point;
a command distinguishing section that distinguishes whether the command received by the command receiving section is a within-protection command that designates an access point within a protected area defined in the visible area or an off-protection command that designates an access point outside the protected area in the visible area;
an off-protection command control section that causes the access section to perform data access to the access point designated by the off-protection command;
a within-protection writing control section that causes, when data writing is designated as the data access by the within-protection command, the access section to write data at an alternative point in the invisible area, and records a correspondence between the access point designated by the within-protection command and the alternative point; and a within-protection reading control section that searches for and finds, when data reading is designated as the data access by the within-protection command, the alternative point corresponding to the access point designated by the within-protection command based on the recorded correspondence, and causes the access section to read data from the found alternative point.

10. The electronic apparatus according to claim 9, further comprising a recovery section that erases data stored outside the protected area among the data stored in the storage area.

11. The electronic apparatus according to claim 10, wherein the within-protection writing control section records the correspondence in a correspondence table, and
the recovery section substantially erases the data stored outside the protected area by erasing the correspondence recorded in the correspondence table.

12. The electronic apparatus according to claim 10, wherein the within-protection writing control section records the correspondence in a correspondence table together with a data written date,
the correspondence table records the correspondence between the access point and the alternative point, and also records a storage point of data stored within the protected area, in the same recording form as a recording form of the correspondence, as a correspondence in which both the access point and the alternative point are at an identical storage point,
the protected area is defined by a group of access points recorded in the correspondence table and increases by accumulating data every time data is written, and
the recovery section erases, in response to designation of a date, a correspondence with a data later than the designated data among correspondences recorded in the correspondence table, thereby substantially erasing data outside the protected area in the past.
